(19) United States
(12) Patent Application Publication
(10) Pub. No.: US 2005/0218048 A1
(43) Pub. Date: Oct. 6, 2005

(54) Oil filter apparatus

(75) Inventor: Yuji Kato, Kanagawa (JP)

Correspondence Address: FOLEY AND LARDNER;SUITE 500, 3000 K STREET NW, WASHINGTON, DC, 20007, US

(73) Assignee: HITACHI, LTD.

(21) Appl. No.: 11/094,528

(22) Filed: Mar. 31, 2005

(30) Foreign Application Priority Data
Apr. 2, 2004 (JP) 2004-110347

(51) Int. Cl. B01D 35/147

(52) U.S. Cl. 210/130; 210/440; 210/443; 210/450

(57) ABSTRACT

There is provided an oil filter apparatus, including a housing provided with a housing body and a cylindrical cap attached to the housing body and having a closed cap end and a plurality of ribs formed integral with an inner surface of the cap end, a cylindrical filter element disposed in the housing and a relief valve assembly held between the filter element and the ribs and having a valve opened in accordance with a pressure difference between inner and outer sides of the filter so as to allow an oil flow to bypass the filter.

### BACKGROUND OF THE INVENTION

The present invention relates to an oil filter apparatus for filtering out a foreign substance from oil, and more specifically to a detachable/attachable filter cap for the oil filter apparatus. Hereinafter, the terms “upstream” and “downstream” are used relative to the direction of oil flow through an oil filter apparatus.

Conventionally, an oil filter apparatus for filtering out a foreign substance such as dust from oil includes a housing having a housing body with oil inlet and outlet and a cap attached to the housing body and a filter element disposed in the housing so that the oil is fed from an oil pump into the housing via the inlet, filtered through the filter element and then discharged out of the housing via the outlet. There arises a large pressure difference between upstream and downstream sides of the filter element, which leads to an increase in load on the filter element, for example, when the filter element becomes clogged or when the oil has a high viscosity. In order to prevent an excessive load on the filter element, the arrangement of a relief valve in the oil filter apparatus has been proposed to establish a communication between the upstream and downstream sides of the filter element and thereby allow an oil flow to bypass the filter element at the time the pressure difference exceeds a certain level as in Japanese Laid-Open Patent Publication No. 2003-117316.

### SUMMARY OF THE INVENTION

As the relief valve is generally disposed in the housing with its valve seat held in contact with the cap, the cap receives an oil pressure from the oil pump. It is thus desired that the cap be high in strength as an insurance against a high oil pressure from the pump. However, the cap requires a heavy wall thickness for high strength. This results in large size and heavy weight of the oil filter apparatus.

It is accordingly an object of the present invention to provide an oil filter apparatus having a filter cap capable of securing high strength without causing an increase in cap wall thickness for size and weight reduction of the oil filter apparatus.

According to a first aspect of the invention, there is provided an oil filter apparatus, comprising: a housing having a housing body and a cylindrical cap attached to the housing body, the cap having a closed cap end and a plurality of ribs formed integral with an inner surface of the cap end; a cylindrical filter element disposed in the housing; and a relief valve assembly held between the filter element and the ribs and having a valve opened in accordance with a pressure difference between inner and outer sides of the filter so as to allow an oil flow to bypass the filter.

According to a second aspect of the invention, there is provided an oil filter apparatus, comprising: a housing having a housing body and a cap attached to the housing body; a cylindrical filter element disposed in the housing; a protrusion provided on an inner end surface of the cap; and a relief valve assembly held between the filter element and the protrusion and having a valve opened in accordance with a pressure difference between inner and outer sides of the filter element, the relief valve assembly having a portion kept from contact with the protrusion so as to define an oil passage through which oil bypasses the filter element.

According to a third aspect of the invention, there is provided an oil filter apparatus, comprising: a housing having a housing body and a cap made of a resinous material and attached to the housing body; a cylindrical filter element disposed in the housing; a plurality of elastic pawls formed integrally with an inner end surface of the cap; and a relief valve assembly held axially to the cap by the pawls and having a valve opened in accordance with a pressure difference between inner and outer sides of the filter element and allow an oil flow to bypass the filter element.

The other objects and features of the invention will also become understood from the following description.

### BRIEF DESCRIPTION OF THE DRAWINGS

FIG. 1 is a section view of an oil filter apparatus according to one exemplary embodiment of the invention.

FIG. 2 is a perspective view of a filter cap of the oil filter apparatus, when viewed from an opening side of the cap, according to one exemplary embodiment of the invention.

FIG. 3 is a perspective view of a filter of the oil filter apparatus according to one exemplary embodiment of the invention.

FIG. 4 is an elevation view of a subassembly of the filter and the cap according to one exemplary embodiment of the invention.

FIG. 5 is a section view of the subassembly of the filter and the cap, when cut across ribs of the cap, according to one exemplary embodiment of the invention.

FIG. 6 is a section view of the subassembly of the filter and the cap, when cut across oil chambers defined between the ribs of the cap, according to one exemplary embodiment of the invention.

### DESCRIPTION OF THE EMBODIMENTS

The present invention will be described below by way of an exemplary embodiment.

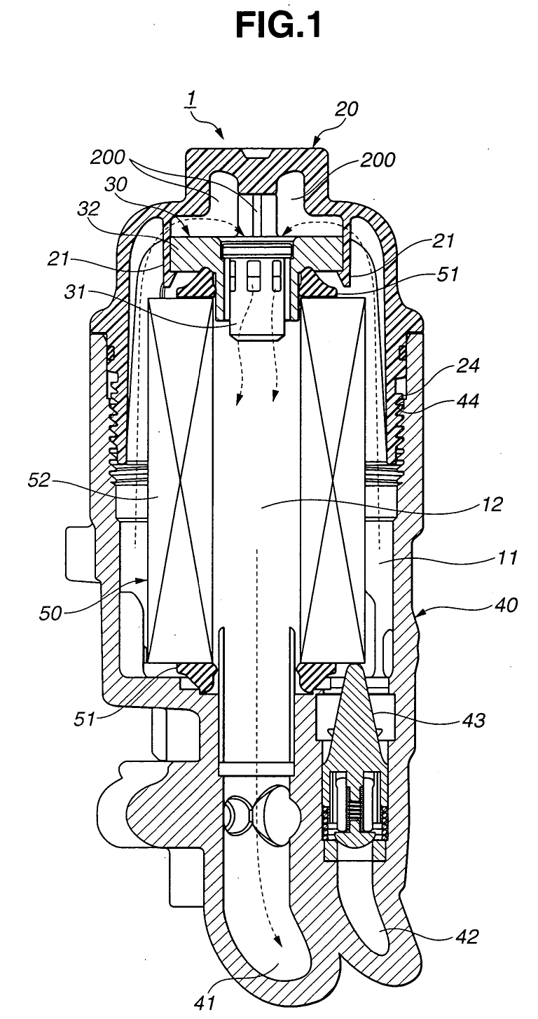

Referring to FIG. 1, an oil filter apparatus 1 of the present embodiment includes a filter housing having a housing body 40 and a cap (or lid) 20 attached to the housing body 40, an oil filter 50 disposed in the housing and a relief valve assembly 30 held between the cap 20 and the filter 50.

The filter 50 has a cylindrical hollow filter element 52 for filtering out a foreign substance such as dust from oil. When the filter 50 is accommodated in the filter housing, there is some space left between the housing body 40 and the filter element 52 and between the cap 20 and the filter element 52, thereby defining an oil chamber 11 into which the oil is fed from an oil pump via an oil inlet. There is further defined through the filter element 52 an oil chamber 12 in which the filtered oil flows. The filter 50 also has elastic members 51 arranged at axially opposite ends of the filter element 52 and brought into contact with the relief valve assembly 30 and the housing body 40, respectively, so as to function as a sealing and shock-absorbing material, when the filter 50, the relief valve assembly 30 and the housing body 40 are placed in position. In the present embodiment, the elastic members 51 are made of rubber.

The housing body 40 is substantially bottomed cylindrical in shape, and has a gallery hole (as an oil outlet) 41 and a drain valve hole 42 formed in a bottom end of the housing body 40. The gallery hole 41 is located in a center bottom end portion of the housing body 40 so as to introduce therethrough the filtered oil from the oil chamber 12 into a main oil gallery. The drain valve hole 42 is opened at a peripheral bottom end portion of the housing body 40 so as to accommodate therein drain valve 43. It is noted that the drain valve 43 becomes opened upon detachment of the cap 20 from the housing body 40 for replacement of the filter element 52 in order to return the oil from the housing body 40 into the oil pump without the oil overflowing from the filter housing. A thread 44 is cut in an inner circumferential surface of the housing body 40 for engagement with the cap 20.

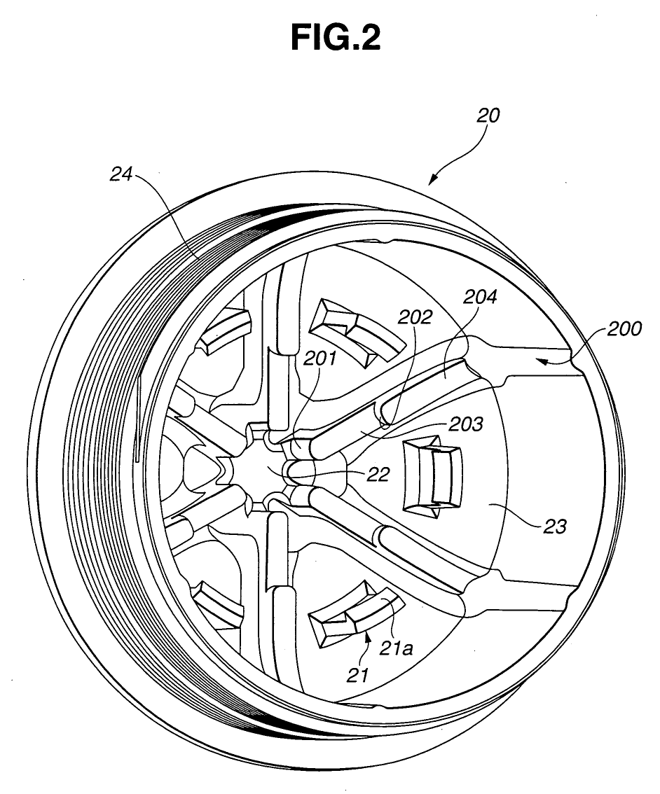

The cap 20 is substantially cylindrical in shape and made of a synthetic resin. As shown in FIG. 2, the cap 20 has a closed cap end, a plurality of reinforcing ribs (or parts) 200 formed on at least an inner surface of the cap end and a plurality of hook-shaped supporting pawls 21 formed on the inner surface of the cap end. Although there is no particular limitation on the numbers of ribs 200 and pawls 21, alternating six ribs 200 and six pawls 21 are aligned radially in the present embodiment. Further, the ribs 200 and the pawls 21 are formed integral with the inner surface of the cap 20 in the present embodiment.

The ribs 200 protrude from the inner cap surface toward the inside of the cap 20 in such a manner as to radiate from the cap center toward the cap rim. Each of the ribs 200 has a rib edge 201, a valve retaining portion 203 protruding from the inner cap end surface and a valve engaging portion 204 protruding more than the valve retaining portion 203 from the inner cap end surface so as to form a step 202 between the valve retaining portion 203 and the valve engaging portion 204.

The edges 201 of the ribs 200 are located at some distance from the cap end center with a little clearance left between each two adjacent rib edges 201, thereby defining an oil chamber 22 surrounded by the rib edges 201.

The valve retaining portions 203 of the ribs 200 extend radially outwardly between the rib edges 201 and the steps 202, and have valve retaining faces formed in parallel with the radius of the cap 20 and brought in contact with the relief valve assembly 30 so as to axially retain the relief valve assembly 30 to the cap 20 when the cap 20, the relief valve assembly 30, the filter 50 and the housing body 40 are placed in position.

The valve engaging portions 204 of the ribs 200 extend radially outwardly from the steps 202 and come into engagement with the relief valve assembly 30 so as to circumferentially lock the relief valve assembly 30 when the cap 20, the relief valve assembly 30, the filter 50 and the housing body 40 are put together.

Further, the ribs 200 are circumferentially evenly spaced such that there is defined an oil chamber 23 between each two adjacent ribs 200 for communication between the oil chamber 11 and the oil chamber 22.

The pawls 21 are circumferentially evenly spaced and located within the respective oil chambers 23 of the cap 20, and have hook ends 2 la to support thereon the relief valve assembly 30 and prevent the relief valve assembly 30 from being dropped into the housing body 40.

Referring again to FIGS. 1 and 2, a thread 24 is also cut in an outer circumferential surface of the cap so that the cap 20 is screwed into the housing body 40 by engagement of the threads 24 and 44.

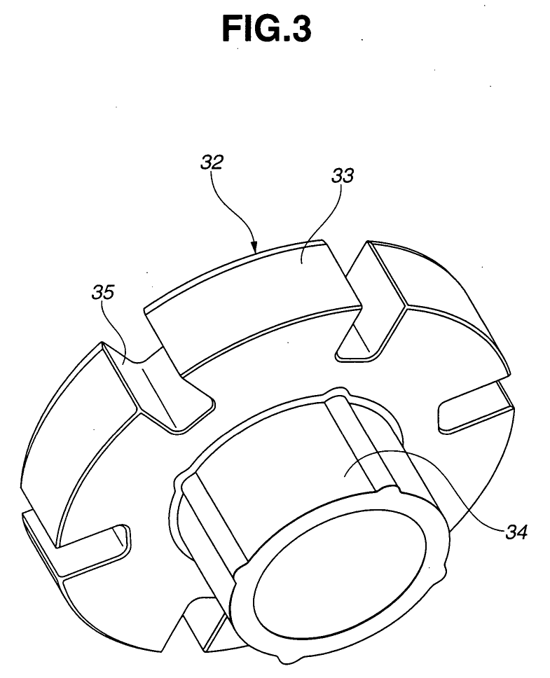

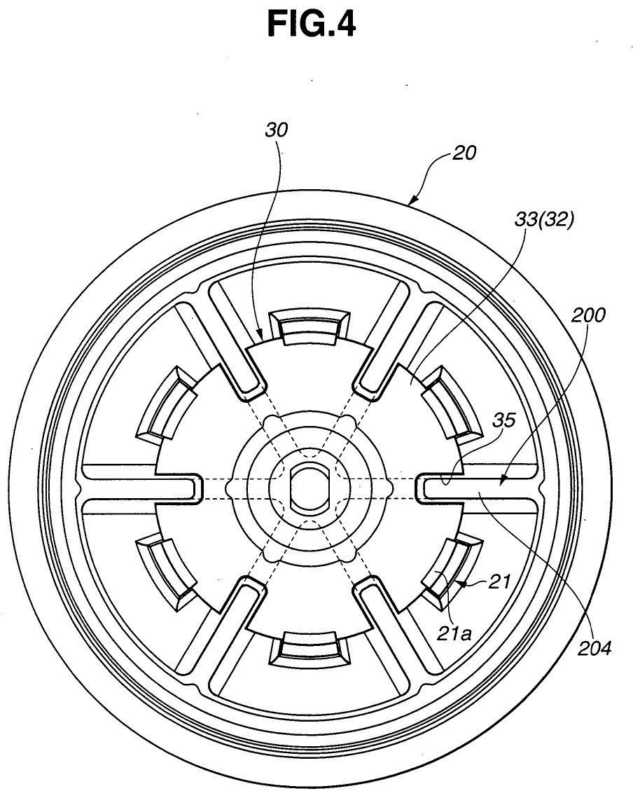

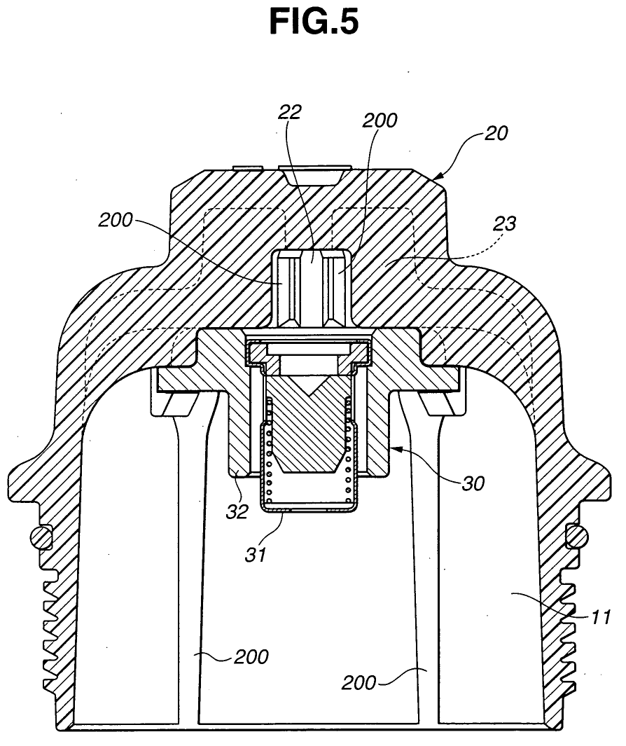

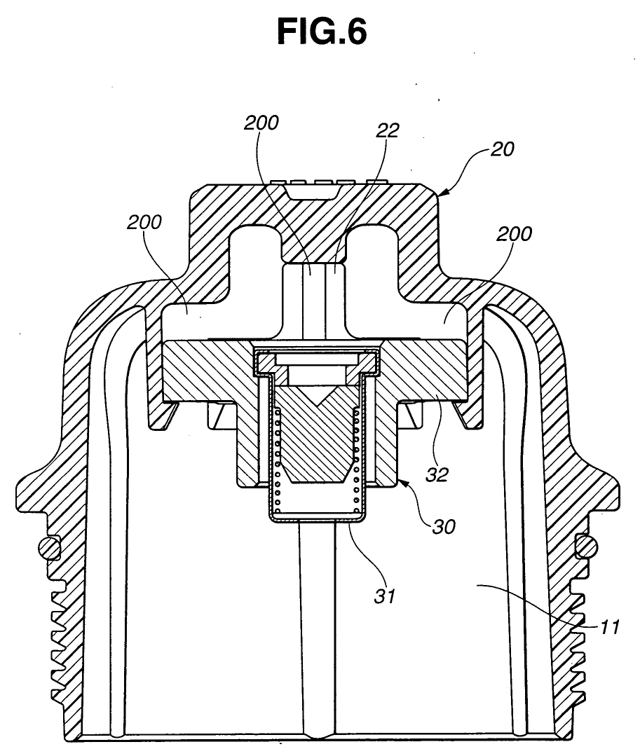

The relief valve assembly 30 includes a relief valve 31 and a hollow valve structure 32 having an axial cavity through which the relief valve 31 is fitted as shown in FIGS. 1 and 3. The relief valve 31 has a valve element biased by a coil spring to close a valve hole under normal conditions. When a pressure difference between upstream and downstream sides (i.e. outer and inner sides) of the filter element 52 exceeds a predetermined level, the valve element is moved against a tension of the spring to open the valve hole and thereby flow the oil through the valve hole. The valve structure 32 includes a valve seat portion 33 at which the relief valve 31 is seated and a portion 34 protruding axially from the valve seat portion 32 so as to accommodate therein the relief valve 31. The valve seat portion 33 has evenly-spaced grooves 35 formed in a circumferential surface thereof for engagement with the valve engaging portions 204 of the ribs 200, respectively. Namely, the grooves 35 functions as an anti-rotation mechanism capable of preventing circumferential rotation of the relief valve assembly 30 in the present embodiment. In order for the valve seat portion 33 to be supported on the hook ends 2 la of the pawls 21, the valve seat portion 33 has an outer diameter larger than a diametrical distance between the pawl hook ends 21 a as shown in FIGS. 4 to 6. As the pawls 21 are formed of a resinous material integrally with the cap 20 and shows such elasticity as to allow insertion of the relief valve assembly 30 in between the pawls 21, the cap 20 and the relief valve assembly 30 can be easily put together by pushing the relief valve assembly 30 into the cap 20 against the elastic force of the pawls 21 along the axial direction.

With the above-described structure, the oil flows through the oil filter apparatus 1 as follows. The oil fed from the oil pump first flows into the oil chamber 11. Then, the oil passes through the filter element 52 and flows in the oil chamber 12 under normal conditions. However, the oil cannot pass through the filter element 52 and builds up within the oil chamber 11, for example, when the filter element 52 becomes clogged with any foreign substance in the oil. The pressure inside the oil chamber 11 becomes increased to cause a pressure rise in the oil chambers 22 and 23 because the oil chambers 22 and 23 are in communication with the oil chamber 11 as shown in FIGS. 1, 4 to 6. There thus arises a pressure difference between the oil chambers 22 and 23 (the upstream side of the filter element 52) and the oil chamber 12 (the downstream side of the filter element 52). At this time, the valve element of the relief valve 31 receives a force caused by the pressure difference between the oil chamber 12 and the oil chambers 22 and 23, and this force acts as a reaction force against the tension of the coil spring. The valve element of the relief valve 31 is moved against the spring tension to open the valve hole when the pressure difference exceeds a certain level. Then, the oil flows from the oil chambers 22 and 23 into the oil chamber 12 through the valve hole and bypasses the filter element 52 as indicated by dotted arrows of FIG. 1, thereby canceling the pressure difference between the oil chamber 12 and the oil chambers 22 and 23.

As the oil filter apparatus 1 receives an oil pressure from the oil pump regardless of whether the filter element 52 is clogged, the pressure inside the oil chambers 22 and 23 continues increasing until the relief valve 31 becomes opened, and then, reaches a high pressure level. It is thus desirable to secure high strength for the cap 20 especially when the cap 20 is made of a resinous material for the purpose of weight reduction.

According to the earlier technology, a filter cap requires a heavy wall thickness so as to secure strength and avoid deformation and breakage. The filter cap of the earlier technology becomes heavier in wall thickness when made of a resinous material. An oil filter apparatus with such a heavy-walled filter cap cannot be made compact and lightweight.

According to the present embodiment, by contrast, the reinforcing ribs 200 are arranged on the inner surface of the cap 20 in a radial arrangement with respect to the cap end center so that the cap 20 can attain sufficiently high strength without an increase in wall thickness. The radial arrangement of the ribs 200 on the inner surface of the cap 20 is particularly effective in improving the strength of the cap 20. By the reinforcement effect of the ribs 200, the cap 20 can be formed of a synthetic resin with sufficient strength and made more compact and lightweight than a metallic cap member. This allows size and weight reduction of the oil filter apparatus 1 for ease of installation.

In a state that the cap 20, the relief valve assembly 30, the filter 50 and the housing body 40 are built into the oil filter apparatus 1, the relief valve assembly 30 is held between the cap ribs 200 and the filter element 52 with the valve seat position 33 of the relief valve assembly 30 being axially retained between the valve retaining portions 203 of the ribs 200 and the hook ends 21 a of the pawls 21 and being circumferentially locked by engagement of the valve engaging portions 204 of the ribs 200 in the grooves 35 of the relief valve assembly 30. A portion of the relief valve assembly 30 is kept from contact with the cap ribs 200 in this state, such that the oil chambers 22 and 23 provide an oil passage from the oil chamber 11 to the relief valve assembly 30. There is no need to give special machining to the relief valve assembly 30 in order to secure the oil passage from the oil chamber 11 to the relief valve assembly 30, whereby the relief valve assembly 30 can remain simple in structure. In addition, the valve retaining portions 203 protrude less than the valve engaging portions 204 from the inner surface of the cap 20. It is thus possible to limit the axial dimension of the oil filter apparatus 1 by contact of such less-protruded valve retaining portions 203 with the relief valve assembly 30. It is also possible to prevent circumferential rotation of the relief valve assembly 30 at the time of replacement of the filter 50 or due to vibrations by engagement of more-protruded valve engaging portions 204 in the grooves 35 of the relief valve assembly 30, so as to avoid wear/abrasion due to the sliding between the relief valve assembly 30 and the ribs 200 and maintain high strength.

There may be used any other means to prevent rotation of the relief valve assembly 30 in place of the ribs 200 and the grooves 35. For example, it is conceivable to form a plurality of axial holes in the relief valve assembly 30 and form a plurality of protrusions on the cap 20 for engagement of the axial holes. In this case, however, the joining of the cap 20 and the relief valve assembly 30 becomes complicated due to positioning of the protrusions and the holes. In addition, the formation of such axial holes in the relief valve assembly 30 is not desirable in view of the cost. The engagement of the valve engaging portions 204 of the cap ribs 200 in the circumferential grooves 35 of the relief valve assembly 30 would be the easier and lower-cost way to prevent circumferential rotation of the relief valve assembly 30.

In the present embodiment, the oil filter apparatus 1 is manufactured by fitting the relief valve assembly 30 in the cap 20 and joining the housing body 40 with the thus-obtained subassembly of the cap 20 and the relief valve assembly 30 in such a manner as to screw the cap 20 into the housing body 40 by engagement of the threads 24 and 44. Each of the pawls 21 is formed between two adjacent ribs 200 to axially support the relief valve assembly 30 on the pawl hook ends 21 and prevent the relief valve assembly 30 from falling off. The cap 20 and the relief valve assembly 30 can be thus easily joined together into a single subassembly by inserting and hooking the relief valve assembly 30 into the pawl hook ends 21a of the cap 20. This allows ease of installation of the relief valve assembly 30. Further, the relief valve assembly 30 can be pressed against the filer 50 so as to establish proper sealing while being prevented from circumferential rotation at the time of screwing the cap 20 into the housing body 40. It is thus possible to avoid wear/abrasion due to the sliding between the relief valve assembly 30 and the ribs 200 and maintain sufficient strength.

The entire contents of Japanese Patent Application No. 2004-110347 (filed on Apr. 2, 2004) are herein incorporated by reference.

Although the present invention has been described with reference to a specific embodiment of the invention, the invention is not limited to the above-described embodiment. Various modification and variation of the embodiment described above will occur to those skilled in the art in light of the above teaching. The scope of the invention is defined with reference to the following claims.

1. An oil filter apparatus, comprising:
a housing having a housing body and a cylindrical cap attached to the housing body, the cap having a closed cap end and a plurality of ribs formed integral with an inner surface of the cap end;
a cylindrical filter element disposed in the housing; and
a relief valve assembly held between the filter element and the ribs and having a valve opened in accordance with a pressure difference between inner and outer sides of the filter so as to allow an oil flow to bypass the filter.

2. The oil filter apparatus of claim 1, wherein the relief valve assembly has an anti-rotation mechanism capable of preventing rotation of the relief valve assembly upon engagement with the ribs.

3. The oil filter apparatus of claim 2, wherein the anti-rotation mechanism has grooves formed in the relief valve assembly so as to engage with the respective ribs.

4. The oil filter apparatus of claim 3, wherein the ribs have first portions protruding from the inner surface of the cap end and second portions protruding more than the first portions from the inner surface of the cap end, the first portions of the ribs are held in contact with the relief valve assembly, and the second portions of the ribs are engaged in the respective grooves.

5. The oil filter apparatus of claim 1, wherein the ribs have first portions protruding from the inner surface of the cap end and second portions protruding more than the first portions from the inner surface of the cap end, and the relief valve assembly comes into contact with the first portions of the ribs.

6. The oil filter apparatus of claim 2, wherein the cap is screwed into the housing body.

7. The oil filter apparatus of claim 1, wherein the cap is made of a resinous material.

8. The oil filter apparatus of claim 1, wherein the ribs are in a radial arrangement with respect to a center of the cap.

9. The oil filter apparatus of claim 8, wherein the cap has a plurality of elastic pawls arranged alternatingly between the respective ribs so that the relief valve assembly is axially supported with the pawls.

10. The oil filter apparatus of claim 9, wherein the pawls allow insertion of the relief valve assembly therebetween so as to prevent the relief valve assembly from falling off.

11. An oil filter apparatus, comprising:
a housing having a housing body and a cap attached to the housing body;
a cylindrical filter element disposed in the housing;
a protrusion provided on an inner end surface of the cap; and
a relief valve assembly held between the filter element and the protrusion and having a valve opened in accordance with a pressure difference between inner and outer sides of the filter element, the relief valve assembly having a portion kept from contact with the protrusion so as to define an oil passage through which oil bypasses the filter element.

12. The oil filter apparatus of claim 11, wherein the protrusion has a plurality of protruding parts so that the oil passage is defined between any adjacent two of the protruding parts.

13. The oil filter apparatus of claim 11, wherein the relief valve assembly has a groove engaged with the protrusion.

14. The oil filter apparatus of claim 13, wherein the protrusion prevents rotation of the relief valve assembly upon engagement with the groove.

15. The oil filter apparatus of claim 11, wherein the protrusion has first and second portions, and the first portion protrudes less than the second portion from the inner end surface of the cap and comes into contact with the relief valve assembly.

16. An oil filter apparatus, comprising:
a housing having a housing body and a cap made of a resinous material and attached to the housing body;
a cylindrical filter element disposed in the housing;
a plurality of elastic pawls formed integrally with an inner end surface of the cap; and
a relief valve assembly held axially to the cap by the pawls and having a valve opened in accordance with a pressure difference between inner and outer sides of the filter element and allow an oil flow to bypass the filter element.

17. The oil filter apparatus of claim 16, wherein the pawls allow insertion of the relief valve assembly therebetween so as to prevent the relief valve assembly from falling off.

18. The oil filter apparatus of claim 17, wherein the pawls are hook-shaped.

19. The oil filter apparatus of claim 16, further comprising an elastic member arranged on the filter element in contact with the relief valve assembly.

20. The oil filter apparatus of claim 16, wherein the pawls are circumferentially evenly spaced.
